(19) United States
(12) Patent Application Publication
(10) Pub. No.: US 2006/0204636 A1
(43) Pub. Date: Sep. 14, 2006

(54) Food for gastrointestinal health

(76) Inventors: Richard F Butterwick, Leicestershire (GB); Vivien Elizabeth Rolfe, Leicestershire (GB)

Correspondence Address: FULBRIGHT & JAWORSKI, LLP, 1301 MCKINNEY, SUITE 5100, HOUSTON, TX, 77010-3095, US

(21) Appl. No.: 10/540,819

(22) PCT Filed: Dec. 23, 2002
(86) PCT No.: PCT/GB02/05913

§ 371 Date: Apr. 3, 2006

(51) Int. Cl. A23L 1/212

(52) U.S. Cl. 426/615

(57) ABSTRACT

The present invention relates to a foodstuff comprising a source of rice starch, a non fermentable fiber and a bulk forming fermentable fiber and, in particular, its use in improving or maintaining the gastrointestinal health of a dog.

### CROSS-REFERENCE TO RELATED APPLICATIONS

This application is the National Phase of International Application No. PCT/GB2002/005913 filed Dec. 23, 2002.

### TECHNICAL FIELD

The present invention relates to a foodstuff comprising a source of rice starch, a non-fermentable fiber and a bulk forming fermentable fiber and its use in improving or maintaining the gastrointestinal health of a dog. The invention further relates to a method of improving the gastrointestinal health of a dog.

### BACKGROUND OF THE INVENTION

It has been observed that a proportion of the dog population exhibit non-specific dietary sensitivity on a range of foodstuffs. This dietary sensitivity can manifest as a variety of clinical symptoms such as vomiting, diarrhea, skin disease, respiratory disorders and disorders of the central nervous system. The causes or dietary drivers of this dietary sensitivity remain elusive. However, common reported allergens in dogs include cow's milk, beef, mutton, pork, chicken, rabbit, horse, some fish, eggs, oatmeal, corn, wheat, soy, rice, potatoes and kidney beans.

Non-specific diet sensitivity is observed with all diets, however it is particularly associated with dogs fed on wet (moisture of 70 to 90%) or semi-wet (moisture of 15 to 70%) foodstuffs. The conventional solution to such non-specific diet sensitivity is to provide the dog with a “sensitive” product usually in the form of a dry diet. However, such a solution is not appropriate or desirable for all dogs. In addition, while a wet diet may exacerbate non-specific dietary sensitivity, sensitivity can also be associated with dry diets. Non-specific dietary sensitivity involves factors such as stress, activity levels and dietary components.

The present invention provides a foodstuff, in particular a wet or semi-wet foodstuff, which can be used to improve and/or treat the symptoms of canine non-specific dietary sensitivity. This foodstuff will allow dogs suffering from non-specific dietary sensitivity to be fed on a wet or semi-wet diet. This will avoid the problems associated with changing a dogs diet from a wet to a dry diet. In addition, the provision of a wet or semi-wet foodstuff provides more choice and flexibility to the owner.

### BRIEF SUMMARY OF THE INVENTION

A first aspect of the present invention provides a foodstuff comprising a source of rice starch, a source of non-fermentable fiber and a source of bulk forming fermentable fiber. For the purposes of this invention, the foodstuff may have a moisture content of from 15 to 90% and is preferably wet (moisture content of 70 to 90%) or semi wet (moisture content of from 15 to 70%).

The foodstuff of the first aspect contains a source of rice starch. The source of the rice starch is not limiting. It can be provided, for example, as rice (either whole or broken grains), ground rice or rice flour. The foodstuff further provides a source of non-fermentable fiber. The source of non-fermentable fiber is not limiting. It may be one or more of cellulose, wheat bran, oat bran or barley bran. The foodstuff further contains a source of a bulk forming fermentable fiber. For the purpose of this invention, bulk forming fibers improve fecal bulk thereby improving transit and Taxation. The source of the bulk forming fiber is not limiting. Preferably, the bulk forming fermentable fiber is one or more of sugar beet pulp, coconut endosperm fiber, chicory pulp, citrus pulp, carob bean or gum talha.

In a preferred feature of the invention a foodstuff is provided comprising rice starch, sugar beet pulp (as a source of bulk forming fermentable fiber) and cellulose (as a source of non-fermentable fiber). The sugar beet pulp is provided at a level of approximately 5% to approximately 0.1% weight/dry weight, preferably, approximately 3% to approximately 0.5%, more preferably at a level of approximately 1.6% or above. Cellulose is provided at a level of 5% to 0.1% weight/dry weight, preferably, approximately 2% to approximately 0.5%, more preferably at a level of approximately 0.8% or above. Rice starch is provided at a level of approximately 5% to approximately 0.1% weight/dry weight, preferably approximately 3% to approximately 0.5%, more preferably at a level of approximately 1.6% or above.

The levels of fiber in a foodstuff can be analyzed using the Englyst method (as defined in Englyst H. N., and Cumming J. H. (1984), Simplified method for the measurement of total non-starch polysaccharides by gas-liquid chromatography of constituent sugars as alditol acetates. Analyst. 109, 937-942, and incorporated herein by reference). A description of the Englyst method is described in Appendix 1. In principle, starch is removed enzymatically after solubilization and NSP is measured as the sum of the constituent sugars released by acid hydrolysis. The starch component of the fiber source is gelatinized by boiling in hot water and is then removed with alph-amylase and pullulanase. Starch and modified, or resistant starch are dispersed in DMSO. Three samples are then subjected to complementary procedures measuring (I) total NSP (ii) water-soluble NSP and (iii) cellulose. Components are hydrolyzed in each case with sulphuric acid. The constituent sugars are converted to alditols and are measured as their alditol acetates using gas-liquid chromatography (GLC). Values for total dietary fiber as well as insoluble and soluble fractions can be obtained. Cellulose can be measured separately and the non-cellulose polysaccharides are characterized by measurement of the individual monosaccharides.

The level of fiber in any particular fiber source can be determined by identifying the amount of fiber therein and comparing the level of fiber provided with that provided by the cellulose or sugar beet pulp as discussed above. The amount of a particular fiber source to add to a foodstuff can then be determined.

When the foodstuff of the first aspect of the invention is provided as a snack or treat, the levels of bulk forming fermentable fiber, non-fermentable fiber and rice starch can be decreased. For example, a snack food may be provided with approximately 0.8% rice starch or above, approximately 0.4% cellulose or above and approximately 0.8% sugar beet pulp or above.

In a preferred feature of the first aspect, the combined levels of non-fermentable fiber and bulk forming fermentable fiber does not exceed approximately 8% w/w, preferably the combined level does not exceed approximately 5% w/w.

The foodstuff according to the present invention encompasses any product that a pet consumes in its diet. Thus, the invention covers standard food products as well as pet food snacks (for example, snack bars, biscuits and sweet products—Preferably, these snackfoods are wet or semi-wet products such as co-extruded pet treats described in EP0647410 or WO99/47000. The foodstuff is preferably a cooked product. It may incorporate meat or animal derived material (such as beef, chicken, turkey, lamb, fish, blood plasma, marrow bone etc or one or more thereof). The product alternatively may be meat free (preferably including a meat substitute such as soya, maize gluten or a soya product) in order to provide a protein source. The product may contain additional protein sources such as soya protein concentrate, milk proteins, gluten etc. The product may also contain an additional starch source (in addition to the source of rice starch) such as one or more grains (e.g. corn, rice, oats, barley etc).

The foodstuff of the present invention may preferable be provided as a liquid supplement. The supplement may be provided as an accompaniment with food or may be added to a conventional foodstuff. Alternatively, the supplement may be provided before or after the conventional foodstuff. The supplement may further be added to a drink such as milk or water.

The foodstuff is preferably packaged. In this way, the consumer is able to identify, from the packaging, the ingredients in the foodstuff or food supplement and confirm that it is suitable for the particular pet in question. The packaging may be metal (usually in the form of a tin or flexifoil), plastic, paper or card. The amount of moisture in any product may influence the type of packaging, which can be used or is required.

According to the present invention, dogs are any canine animal, in particular the domestic or pet dog, Canis domesticus.

The second aspect of the invention relates to a process for the manufacture of a foodstuff of the first aspect of the invention. The process comprises admixing a source of rice starch, a non-fermentable fiber and a bulk forming fermentable fiber. The foodstuff can be made according to any method known the art such as in Waltham Book of Dog and Cat Nutrition, Ed. ATB Edney, Chapter by A. Rainbird, entitled “A Balanced Diet” in pages 57 to 74 Pergamon Press Oxford. All preferred features of the first aspect also apply to the second.

The third aspect of the invention relates to a foodstuff of the first aspect for use in improving and/or maintaining the gastrointestinal health of a dog. Improving and/or maintaining the gastrointestinal health of an animal is a long held aim in the art, particularly in dogs suffering from non-specific dietary sensitivity. The ability to maintain and/or improve gastrointestinal tract health can be beneficial to pet owners because it has an impact on their pet's overall health.

A dog with non-specific dietary sensitivity has sub-optimal intestinal health. This increases the risk of the dog developing viral or bacterial infections and compromises its long-term health. The foodstuff of the invention is preferably provided for improving and/or maintaining the gastrointestinal health of a dog with a canine non-specific dietary sensitivity.

The inventors have previously showed that dogs with a non-specific dietary sensitivity exhibit impaired water and electrolyte absorption. Furthermore, a dog with non-specific dietary sensitivity also exhibits a rapid whole gut transit time. These colonic abnormalities result in poor feces. In addition, dogs with non-specific dietary sensitivity have diarrhea and sub-optimal intestinal health. Without being bound by scientific theory, the foodstuff of the first aspect is believed to drive absorption and regulate whole gut transit time in dogs with non-specific dietary sensitivity. This leads to an improvement in the gastrointestinal health of these dogs.

By improving the gastrointestinal health of the animal, the invention seeks to promote and maintain good quality feces in pet animals. Good feces quality is of two-fold importance. Firstly, it is a good indicator of a healthy pet. It is known that good feces quality usually reflects healthy colonic structure and function. Secondly, it is a much-favored practicality for pet-owners. The invention therefore provides a foodstuff of the first aspect for improving and/or maintaining feces quality in a dog.

Improving and/or maintaining gut health includes: improving and/or maintaining the gut motility of a dog. The foodstuff of the first aspect improves whole gut transit time in a dog with non-specific dietary sensitivity; improving and/or maintaining the absorption of electrolytes and colonic water in the gastrointestinal tract of a dog. This improves feces quality and prevents and/or reduces diarrhea in a dog with non-specific dietary sensitivity.

By improving the gastrointestinal health of a dog, the gastrointestinal tract is able to operate more efficiently, leading to further improvements in the overall health of the dog.

It has been found that the foodstuff of the first aspect of the invention comprising a source of rice starch, a source of non-fermentable fiber and a source of bulk forming fermentable fiber is more efficient and effective than a foodstuff containing one or a combination of two of the components. It is therefore submitted that the components, a source of rice starch, a source of non-fermentable fiber and a source of bulk forming fermentable fiber interact to provide a synergistic result. The foodstuff therefore provides improved benefits to a dog with non-specific dietary sensitivity.

The foodstuff of the third aspect can be administered to a dog in place of its conventional food. The foodstuff can be administered alone or in combination with a dry food or snack. Preferably, the foodstuff of the invention is administered to the dog daily, more preferably twice daily. Where the foodstuff is administered as a snack or treat, the foodstuff is administered to the dog one or more times a day, for example up to five times daily.

The fourth aspect of the invention relates to the use of a foodstuff of the first aspect to improve and/or maintain the gastrointestinal health of a dog. The dog is preferably in need of improvement in gastrointestinal health and may suffer from non-specific dietary sensitivity.

All preferred features of the first, second and third aspects of the invention also relate to the fourth aspect.

The fifth aspect of the invention relates to a method of improving the gastrointestinal health of a dog. The method comprises administering to the dog, the foodstuff of the first aspect. The dog may be suffering from non-specific dietary sensitivity. Administration is preferably by feeding.

All preferred features of the first, second, third and fourth aspects also apply to the fifth aspect.

The sixth aspect of the invention relates to the use of a source of rice starch, a non-fermentable fiber, and a bulk forming fiber in the manufacture of a foodstuff wherein the foodstuff is for improving and/or maintaining gastrointestinal health in a dog.

All preferred features of the first, second, third, fourth and fifth aspects of the invention also apply to the sixth aspect.

### DETAILED DESCRIPTION OF THE INVENTION

The invention will now be illustrated with reference to the following non-limiting examples.

### EXAMPLES

Methods

A panel of ten control and ten sensitive dogs were fed either a standard foodstuff or a foodstuff comprising rice starch, cellulose and sugar beet pulp (supplemented food). The dogs were fed in accordance with individual energy requirements.

Both foodstuffs were wet foods with moisture levels of 78-79%. The major protein sources for each diet were poultry, beef, wheat and maize. The supplemented food was supplemented at the levels set out below (percentages relate to weight per dry weight):

| | |
|---|---|
| Rice starch | 1.6% |
| Cellulose | 0.8% |
| Sugar beet pulp | 1.6% |

The diets were fed in a cross-over design that included a washout phase.

Experimental Design Summary

| | Control | | Sensitive | Sensitive |
|---|---|---|---|---|
| Timings | (n = 5) | Control (n = 5) | (n = 5) | (n = 5) |
| Phase 1 | Std | Std | Std | Std |
| 3 weeks | | | | |
| 1 week | Std | Supplemented | Std | Supplemented |
| | | food | | food |
| Phase 2 | Std Washout | | Std Washout | |
| Phase 3 | Std | Std | Std | Std |
| 3 weeks | | | | |
| 1 week | Supple- | Std | Supplemented | Std |
| | mented | | food | |
| | food | | | |

Measurements

Feces quality was assessed daily using the WCPN 17-point linear scale. All defecations were scored with a score of grade 1 representing dry crumbly feces and grade 5 diarrhea. Major intermediate points are at grade 2—ideal, well formed, does not leave a mark, easy to pick up; grade 3—good quality slightly moist, less well formed, leaves a marked when removed from a dry surface, tacky to the touch, soft centered; and grade 4—poor quality, moist, badly formed feces with consistency of putty or porridge. Statistical comparisons were made on the 7-day period during which supplemented food was fed.

At the end of phase 1 and 3 standard and functional measurements were made:

Colonic transport function was measured using dialysis bags.

Whole gut transit time was measured by calculating the mean rate of transit of barium impregnated polyethylene spheres (BIPS) through the intestinal tract. Briefly, 20 pellets were administered with the early morning feed and all feces voided collected for 4 days. Feces were x-rayed and the numbers of BIPS evacuated counted.

The mean whole gut transit time (WGTT) was calculated using the following equation:

$$WGTT ( hours ) \frac{\sum no . pellets ( I ) \times time {interval ( i )}_{( i = 1 - n )}}{\sum no . pellets {( I )}_{( i = 1 - n )}}$$

Statistics

All data is expressed as the mean±the standard error of the mean. Statistical significance of all parameters was measured using Multifactoral Anova with significance assumed at p<0.05.

Results

Feces Quality Results

| | | |
|---|---|---|
| Mean Score | % | Fecal output (per |
| (SEM) | Unacceptable | dog per day) |

Control

| | | | |
|---|---|---|---|
| Std | 2.3 (0.05) a | 2.4 | 1.7 a |
| Supplemented Food | 2.1 (0.03) a | 0.5 | 1.9 a |

Sensitive

| | | | |
|---|---|---|---|
| Std | 2.7 (0.05) c | 11.1 | 2.5 a |
| Supplemented Food | 2.4 (0.04) b | 3.9 | 2.3 a |

The feeding of diet supplemented with rice starch, cellulose and sugar beet dramatically improved the feces quality of the sensitive dogs.

Colonic Electrolyte Transport

Electrolyte transport (mM.hour) (−ve value = absorption)

Na+

Control

| | |
|---|---|
| Std | −53.3 (10) b |
| Supplemented food | −65.8 (8.8) b |

Sensitive

| | |
|---|---|
| Std | −64.1 (9.4) b |
| Supplemented food | −94.9 (9.3) a |

Sensitive dogs showed significantly improved sodium absorption (indicating by a more negative value) from the colon when fed the supplemented foodstuff.

Whole Gut Transit Time

Administration of the supplemented food to sensitive dogs significantly improved the whole gut transit time, as indicated by an increase in the time of transit, improving times present to those observed in controlled dogs.

Mean Whole Gut Transit Time (Hours) [Standard Deviation]
Control dogs

| | |
|---|---|
| Standard food | 31.1 [10.6]b |
| Supplemented food | 26.0 [5.2]ab |

Sensitive dogs

| | |
|---|---|
| Standard food | 21.6 [5.2]a |
| Supplemented food | 28.4 [8.5]b |

Effectiveness of Foods Comprising Rice Starch, Cellulose or Sugar Beet Pulp on Feces Quality.

| | Standard | 0.8% | 1.6% Sugar | 1.6% Rice |
|---|---|---|---|---|
| | food | Cellulose | beet pulp | starch |
| Control | 2.28⁺ 0.4 b | 2.13⁺ 0.23 a | 2.23⁺ 0.37 b | 2.23⁺ 0.40 b |
| dogs | | | | |
| Sensitive | 2.28⁺ 0.39 b | 2.15⁺ 0.24 a | 2.21⁺ 0.28 ab | 2.23⁺ 0.34 ab |
| dogs | | | | |

Thus, the effects of feeding each of the components separately provides less benefit than providing a combination of the components.

Appendix 1

The Englyst method, from Englyst and Cummings (Supra).

Experimental

Apparatus

The fractionation procedure was carried out in 50-60 ml screw-topped glass centrifuge tubes as previously described. Gas-liquid chromatography was performed with a Pye Unicam Series 204 chromatograph, fitted with a flame-ionization detector. A 2.1 m×2 mm i.d. glass column packed with Supelcoport (100-200 mesh) coated with 3% SP 2330 was used. The column temperature was 215° C. (isothermal) and the injector and detector temperatures were 250° C. The carrier gas (nitrogen) flow-rate was 20 ml min-¹.

Reagents

High purity certified reagents were used for all analyses. Enzyme preparations were as follows: hog pancreatic α-amylase, E.C.3.2.1.1. (Sigma, Cat. No. A4268); pullulanase, E.C.3.2.1.41. (Boehringer, Cat. No. 108944).

Method

The sequence of steps in the procedure is summarized below.

Pre-Treatment of Sample

As far as possible, foods should be analyzed without any pre-treatment. If there are problems in taking a representative sample, foods with a low water content can be ball milled for 2-3 minutes, and those with a higher water content homogenized, or freeze-dried and ball milled.

Sample Mass

Accurately weigh between 50 and 1,000 mg of sample, containing not more than 150 mg of starch and 50 mg of NSP, into a 50-60 ml screw-top centrifuge tube and add a stirrer.

Fat Extraction and Drying

Samples with dry matter between 90 and 100% and with less than 203% of fat can be analyzed directly. Otherwise, add 40 ml of acetone, mix for 30 minutes by using a magnetic stirrer, centrifuge and remove by aspiration as much of the supernatant as possible without disturbing the residue. Place the tubes in a water bath at 65° C. on a magnetic stirrer hot plate and mix the residue for a few minutes until it appears to be dry. The beaker can be covered and the acetone vapor removed by water pump.

Dispersion of the Starch

Add 2 ml of DMSO, cap the tube and heat it in a boiling water bath for 1 hour, timed from when re-boiling commences, stirring continuously. Then, without cooling, add 8 ml of 0.1M sodium acetate buffer pH5.2, at 50° C. and vortex mix immediately. 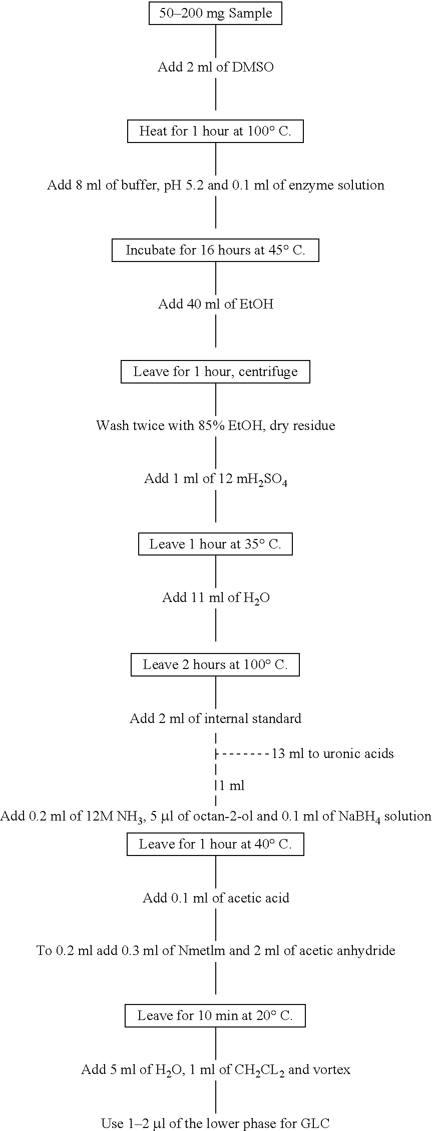
Procedure for the Analysis of Non-Starch Polysaccharides (NSP)
Enzyme Hydrolysis of the Starch

Cool the tube to 45° C. and immediately add 0.1 ml of an enzyme solution containing 5,000 units of α-amylase and 5 units of pullulanase per ml of acetate buffer at pH 5.2. Incubate the samples at 45° C. for 16-18 hours, preferably mixing continuously as described previously.

Following the enzyme treatment, add 40 ml of absolute ethanol, mix well and leave to stand for 1 hour at room temperature. Centrifuge for 10 minutes or until a clear supernatant liquid is obtained. Removed by aspiration as much of the supernatant liquid as possible, without disturbing the residue, and discard it. Wash the residue twice with 50 ml of 85% ethanol by mixing to form a suspension, centrifuging until clear and removing the supernatant liquid as before. Add 40 ml of acetone to the washed residue, stir for 5 minutes and then centrifuge. Remove the supernatant liquid by aspiration and dry the residue as described under Fat extraction and drying.

Acid Hydrolysis of the Residue From Enzymic Digestion

Disperse the dried residue in 1 ml of 12M sulphuric acid, using a vortex mixer. Leave at 35° C. for 1 hour to solubilize the cellulose, then rapidly add 11 ml of water and mix.

Heat the solution in a boiling water bath for 2 hours from re-boiling, stirring continuously. Cool it to room temperature by placing the tube in water, add 2 ml of internal standard (2 mg of allose per ml of saturated benzoic acid solution) and mix the contents of the tube. Use 1 ml of the hydrolysate for the preparation of alditol acetates and keep the remainder for the determination of uronic acids.

Uronic Acids

The method used is a modification of the method of Scott. Mix 0.3 ml of hydrolysate (diluted, if necessary, so that it contains between 25 and 100 μg of uronic acids per ml) with 0.3 ml of a mixtures of sodium chloride-boric acid solution (prepared by adding 2 g of sodium chloride and 3 g of boric acid to 100 ml of water) Add 5 ml of concentrated sulphuric acid and vortex mix, then place the tube in a heating block at 70° C. Leave the tube and contents for 40 minutes and then cool them to room temperature by placing in water. When cool, add 0.2 ml of 3.5-dimethylphenol solution (0.1 g of (CH₃)₂—C₆H₃OH in 100 ml of glacial acetic acid) and mix immediately. Between 10 and 15 minutes later read the absorbance at 400 and 450 nm in a spectrophotometer against a water reference. Subtract the reading at 400 nm from that at 450 nm for each sample and plot the difference obtained for glucuronic acid standards (over the range 25-125 μf ml-¹). Read the sample concentrations from the graph.

Preparation of Alditol Acetates

To 1 ml of hydrolysate add 0.2 ml of 12M ammonia solution and 5 μl of octan-2-ol. Test that the solution is alkaline, and then add 0.1 ml of a freshly prepared solution of 100 mg of sodium tetrahydroborate (III) (sodium borohydride) per ml of 3M ammonia solution. Mix, leave the mixture for 1 hour at 40° C. and add 0.1 ml of glacial acetic acid. Next, to 0.2 ml of the acidified solution add 0.3 ml of N-methylimidazole and 2 ml of acetic anhydride, and mix. Leave it for 10 minutes at 20° C. (room temperature), add 5 ml of water, mix, and when cooled add 1 ml of dichloromethane, agitate the contents vigorously on a vortex mixer and centrifuge for a few minutes to separate the mixture into two phases. Remove the bulk of the upper phase by aspiration and discard it, then transfer the lower phase to a small vial, seal and store it at −20° C. Use 1-2 μl for injection on to the chromatograph.

Alternative Preparative of Alditol Acetates

When dichloromethane is used as a solvent for the alditol acetates it has been observed in a number of laboratories without automatic GLC injection facilities that the injection technique is critical to the obtaining of reproducible results. A more robust method can be obtained if dichloromethane is replaced with ethyl acetate as a solvent for alditol acetates. The procedure is as follows:

To 1 ml of hydrolysate add 0.2 ml of 12M ammonia solution and 5 μl of octan-2-ol. Test that the solution is alkaline, then add 0.1 ml of a freshly prepared solution of 100 mg of sodium tetrahydroborate (III) per ml of 3M ammonia solution. Mix, leave the mixture for 1 hour at 40° C. and add 0.1 ml of glacial acetic acid. To 0.5 ml of the acidified solution add 0.5 ml of N-methylimidazole, 5 ml of acetic anhydride and mix. Leave for 10 minutes at 20° C. (room temperature), then add 0.6 ml of ethanol and mix. After 5 minutes add 5 ml of water, place in a water bath at room temperature, add 5 ml of 7.5M KOH and a few minutes later a further 5 ml of 7.5M KOH. Mix by inverting and leave to separate into two phases. Transfer the top phase to a small vial and store at +5° C. Use 1-2 μl for injection on the chromatograph.

1. A foodstuff comprising a source of a rice starch, a non-fermentable fiber and a bulk forming fermentable fiber.

2. The foodstuff as claimed in claim 1 wherein the foodstuff is a wet or semi-wet foodstuff.

3. The foodstuff as claimed in claim 1 wherein the source of rice starch is rice, ground rice or rice flour.

4. The foodstuff as claimed in claim 1 wherein the non-fermentable fiber is cellulose.

5. The foodstuff as claimed in claim 1 wherein the bulk forming fermentable fiber is sugar beet pulp.

6. The foodstuff as claimed in claim 1 wherein the foodstuff improves the gastrointestinal health of a dog.

7. The foodstuff as claimed in claim 6 wherein the dog has non-specific dietary sensitivity.

8. The foodstuff as claimed in claim 6 wherein the foodstuff improves intestinal function in a dog.

9. The foodstuff as claimed in claim 6 wherein the foodstuff improves gut motility in a dog.

10. (canceled)

11. A method of improving the gastrointestinal health of a dog comprising administering a foodstuff as claimed in claim 1.

12. A method for preventing diarrhea in a dog comprising administering a foodstuff as claimed in claim 1.

13. (canceled)

14. A process for the manufacture of a foodstuff as claimed in claim 1 comprising admixing a source of rice starch, a non-fermentable fiber and a bulk forming fermentable fiber.

15. The foodstuff as claimed in claim 1 comprising of rice starch at a level of approximately 5% to approximately 0.1% w/w.

16. The foodstuff as claimed in claim 1 comprising sugar beet pulp at a level of approximately 5% to approximately 0.1% w/w.

17. The foodstuff as claimed in claim 1 comprising cellulose at a level of approximately 5% to approximately 0.1% w/w.
